(19) United States
(12) Patent Application Publication
(10) Pub. No.: US 2009/0265869 A1
(43) Pub. Date: Oct. 29, 2009

(54) ELECTRIC BIDIRECTIONAL ROTATION REVERSIBLE TOOTHBRUSH WITH SPEED REDUCING CASE

(76) Inventor: RAFAEL GONZALEZ, Bogota, CO (US)

Correspondence Address: ROBERTO J. RIOS, 256 ELEANOR ROOSVELT, SAN JUAN, PR, 00918, US

(21) Appl. No.: 12/108,506

(22) Filed: Apr. 23, 2008

(51) Int. Cl. A61C 17/26; A61C 17/22; A61C 17/16; A46B 13/02

(52) U.S. Cl. 15/22.1

(57) ABSTRACT

This invention is related to an electric brush that provides a correct, harmless and easy brushing for the human oral health and cleaning, it also may be used in the therapeutic hygiene of handicapped persons and even in veterinary use for related animals. It has reloadable batteries. It includes a reversible electric motor, a reducer gear cage, a cylindrical or conic brush with special bristles in all its surface (360°), a cabling and electric switches of 3 position that achieves a complete EFFICIENT ROTATION of the brush in 2 directions manually changeable, one of them clockwise and the other one counterclockwise to make the brushing of the teeth in the right direction required and recommended by the dentists for the gums of each maxillary. This is the only one brush that due to its design of shape and bristles and its reducer gear cage that balances and harmonizes the speed-force-torque for an EFFICIENT ROTATION, gets an EFFICIENT AND HARMLESS BRUSHING without harmful side effects.

### TECHNICAL FIELD

Within the human health field, specifically, in the areas of cleaning and oral health, this invention is related to an electric toothbrush with a mechanism of brush axis rotation in bi-directional way that starting from a combination of force of an electric motor applied to a speed reducing case with satellite double set of gears and with a cylindrical brush element gets an efficient and harmless cleaning-polish-massage effect.

### PRIOR ART

In the state of the art there are manual use toothbrush and toothbrush electrically powered. The patents of the United States of America U.S. Pat. No. 3,270,360, U.S. Pat. No. 4,084,280, U.S. Pat. No. 4,313,237, and U.S. Pat. No. 6,453,498 refer to the use of electric power to generate the movements of a toothbrush cleaning the dental surface.

U.S. Pat. No. 4,397,055 of August-1983, (Mr. Cuchiara Samuel M.) and U.S. Pat. No. 3.661.018 Mayo-1972, (Mr. Keefer and Mr. Samorian) deserve special attention since they describe the electric brush with rotational clockwise and counterclockwise bi-directional movements. In spite of its mechanical solution it is not efficient because it uses the motor power directly, resulting in an instable torque force in the brush axis.

### TECHNICAL PROBLEM

The manual and/or electric toothbrush have been known as “of limited effects” with limited cleaning efficiency. That is why the criticisms from the most demanding dentists recommend using them as adjuvant of a good brushing, but they must not trust them and omit a detailed and sufficiently long brushing, because the electric toothbrush, in general, is not a guaranty of a good brushing.

Additionally, if we would use the technology of micro cameras located in the effect or impact point of the brushing on the teeth, on the gums and on the gums line, we would see the micro-pricking effects caused by the bristle tips hitting and attacking the gums in their most critical point which is the teeth-gum proximity. That is why the oscillating movements, of axial or rotational back and forth are undesirable, because although they improve the cleaning and removal in the hard part (teeth), they do not have a harmless effect on the soft part (gum).

Most of the existent electric and/or manual toothbrush, REQUIRE and depend from the user's hand and/or arm, and have the problem of attacking the gums line and uncover the dental neck, which is an effect that depends on, and functions with the good individual's consistent movements, on the manual skill and the discipline of each person. The medical statistics report high indexes of oral diseases caused by a poor brushing. The average poor manual skills and the very frequent hurry and rush of the modern life, along with a poor immobilization of the available brushes explain this.

Finally, it is important to say that some existent electric toothbrushes are based in levies, solenoids and gear-crowns, to change the motor axis rotation movements in axial, vibrator, and oscillating movements, etc. But none of them use a reducing case of powered screw driver satellite gears, which is the most dependable and hardy to offer a solid angular force for a controlled and efficient brushing.

The category of oscillating-based electric brushes, have a great limitation due to their short angular path, offering short displacement movements with quick return in the movement direction, limitation that aggravates the quick hit against the gums line. (They are not harmless).

U.S. Pat. No. 4,397,055 of August-1983, (Mr. Cuchiara Samuel M.) and U.S. Pat. No. 3,661,018 May-1972, (Mr. Keefer and Mr. Samorian) deserve special attention since they describe the electric brush with rotational clockwise and counterclockwise bi-directional movements. In spite their mechanical solution, they do not include a gear reducing case, which may reduce substantially their effectiveness, given the absence of a reducing case obliging to use in a direct form the force of the motor, which offers an instable angular force to the brush axis. This is reflected in a severe, unstable and mistrusted variation in the brush rotation speed, and even in abrupt halts and stops when it gets in operational touch against the maxillary being able to cause lacerations in the gums. Such patents also include an axial oscillating movement of selective use that, although it may improve the removal of residuals and particles from the hard part (teeth), it tends to attack the soft part of the gums line (gum line) as aforesaid.

### TECHNICAL SOLUTION

Brush the teeth correctly and in an harmless way without hitting or attacking the gums, following the already world diffused and accepted form with directional rotation movements as follows: “in the upper maxillary always brush downward; in the lower maxillary always brush upward”, this seems an easy task but it is not. Make this efficiently requires a good grade of skill and ability in the movement of the arm and the hand, in such a way that the average modern homo-sapiens may seems clumsy and poorly evolved in his physiological and muscular structure to make this “recent” and habitual manual function of the dental brushing.

Unfortunately, the toothbrushes currently available in the market have not solved this problem; both, manual as well as electric brushes, have innovated a lot the shape and composition of their bristles, and have included adjuvant movements and rotations, but none of them makes the rotation movements of the brushing in the directions normatively indicated by the professional dentists; they are, extremely, dependents from the person's limited manual skills.

That is why the reversible electric toothbrush of bidirectional rotation with speed reducing case proposed herein, has been specifically developed to solve this problem of dependence unsatisfied until this moment; the reversible electric toothbrush of bidirectional rotation with speed reducing case achieves for first time a good, quick and harmless brushing, with a minimum dependence from the manual skill grade. The new reversible electric toothbrush of bidirectional rotation with speed reducing case gets to brush with just put it in touch with the dental line, because its bidirectional rotation makes that the brushing work may be quicker and efficient. It even permits that a person may brush another easily, as the case of children, sick and disabled people.

This invent solves the problem of the very repetitive micro-impacts caused by the toothbrush bristle tips on the gums line, caused by mechanical or electromechanical devices and by the movement of the human arm and hand. The solution is a strictly rotation movement in the right direction favoring the gums of each maxillary.

The action of the continuous brushing, such as was just described, requires a continuous action cylindrical brush. This brush must works with appropriate force-torque-speed, which hardly, may be obtained from a direct contact with a motor. That is why this design has the innovation of using a reducing case of satellite gears, which permits to optimize and balance the motor speed, the torque force and the brush final speed. This balance is indispensable to obtain a firm, continuous, uniform, efficient and harmless brushing action.

The reversible electric toothbrush of bidirectional rotation on its own axis makes an operation of brushing of the tooth depending from the power and speed of the movements generated by the user's wrist. This characteristic generates a stable torque force to the brush axis, which is reflected in a stable rotation speed of the brush, without abrupt halts or stops that may cause lacerations to the gums when the brush gets in operational touch with the maxillary.

The invention provides an electric brush that through the use of a bidirectional electric motor, a cabling and the appropriate switch, permits that the brush rotates in the right direction for the cleaning of the upper or lower maxillary such as it is required to favor the gums.

The reversible electric toothbrush of bidirectional rotation on its own axis executes a mechanism so that its bristles may clean in the gum-teeth direction, without uncovering the dental neck and without hitting the gums, since the movement of its bristles is made through the force of a motor of 0.02 HP which decreases its rotation speed from ≧1250 RPM to ≦210 RPM through a reducer speed cage with gears that balance the characteristics of speed-torque force when the electric toothbrush is powered to clean the gum-teeth.

The reversible electric toothbrush of bidirectional rotation on its own axis executes a continuous action produced by the continuous rotation movement through the use of a mixing of bristles, both of flexible nylon as well as of nylon that secures an efficient and harmless cleaning.

The composition of bristles of the reversible electric toothbrush of bidirectional rotation on its own axis has a 70-80% of nylon bristles penetrating the spaces between tooth and the patches of the molar bases and between 20-30% of rubber bristles that polish and clean the teeth.

To decrease the intensity of the hits when the brush gets in touch with the internal parts of the mouth, the electric toothbrush of bidirectional rotation on its own axis has a rubber cover in its upper end.

### ADVANTAGES OF THE INVENTION

The reversible electric toothbrush of bidirectional rotation with speed reducing case is a brush of complete bidirectional rotation that offers a brushing in the natural direction of the teeth and gums. In its correct and normal operation it brushes by hitting against the gums line.

The reversible electric toothbrush of bidirectional rotation with speed reducing case in its correct brushing operation has minimum dependence from the grade of manual skill or ability of the person, because the brush is the one that makes the brushing operation and not the movement of the hand or the wrist. Even, it is suitable for special persons with limited manual skills.

The electric toothbrush of bidirectional rotation with speed reducing case offers a high efficiency and velocity in the brushing due to its optimum mixing of rubber bristles for a licking leaving smoothness and nylon bristles that remove and clean the inter-dental spaces.

The electric toothbrush of bidirectional rotation with speed reducing case offers a brushing of high harmless, because it's soft bumper avoids hits in the gums and its correct rotation does not work against the gums line. It does not have any hard parts in touch. It does not hurt any part of the mouth.

The electric toothbrush of bidirectional rotation with speed reducing case saves time in the brushing because the rotational speed offers a gentle and fast cleaning, with ten times more scrubbing of bristles compared to the speed of the manual brushing. A person with a normal ability may spend a brushing time of 1, 5 to 1.8 minutes. This is very important because the modern life hurry causes a poor or incomplete brushing and a poor oral health-hygiene.

The reversible electric toothbrush of bidirectional rotation with speed reducing case offers a brushing of great therapeutic aid, since its bidirectional rotation favoring the gums gradually recovers the cover of the uncovered necks and its smooth massage avoids the gingivitis or gums inflammation.

The reversible electric toothbrush of bidirectional rotation with speed reducing case has an environmental friendly design, because the re-change of the brush is a short disposable component with degradable fibers and a main body of long lifespan.

The ergonomic design of the reversible electric toothbrush of bidirectional rotation with speed reducing case has a texture of antiskid rubber permitting a good grasping, also it requires few position changes against the dental line sin the brushing is made by the rotation of the brush and not by the hand movement which only must displace along the dental line.

The design of the reversible electric toothbrush of bidirectional rotation with speed reducing case and its optimum speed allow a not very noisy operation, because its mechanism does not use a high vibratory, oscillatory or sonic frequency avoiding the annoying noise that in some cases may recall the drill used by the dentist and it may create a subconscious resistance of use by the user.

The reversible electric toothbrush of bidirectional rotation with speed reducing case due to its design has optimized the force and speed of brushing versus the power consumption, achieving a good brushing without abrupt halts or stops of the brush and avoiding wounding frictions or lacerations in the mouth and gums.

The design of the reversible electric toothbrush of bidirectional rotation with speed reducing case is resistant to the wet penetration and the cord-less reload system through a wireless current adapter transformer, without exposition of current sources or terminals, offers high security against the eventual electric shock and photocells.

The reversible electric toothbrush of bidirectional rotation with speed reducing case has a simple and reliable mechanical design that uses the components of the motor, a gears reducer, batteries etc. with easy manufacturing and/or commercial acquisition.

### DESCRIPTION OF FIGURES

FIG. 1: Brush sectioned view

FIG. 2: Reducing case detailed view

FIG. 3: detailed view of the brush and of the bristle assembly device

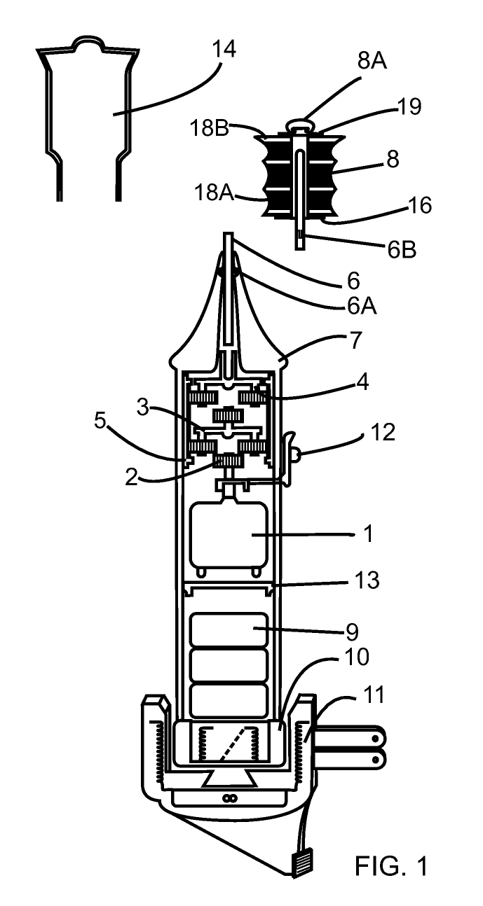

According to FIG. 1, the electric toothbrush is shown illustrating the adaptation assembled with a novel gear reducing case. The device has a structural tubular chassis (7), with a first component in its terminal tip of inferior base which is a load secondary electric coil (10) that receives electric load by inductance. This terminal tip is completely flat in order to serve as base and support so that the brush remains in a vertical position. This terminal tip is introduced in the hole of a support base (11), constituting a socket-base-plug, containing a primary coil that transforms the network power and gives electric load by inductance to the secondary coil.

Then, it is located within a compartment of the chassis, a package of reloadable batteries (9), batteries that must provide 3.2 Volts and greater than or equal to ≧900 milliamperes hour. Then, a partition comes from the batteries package (13), this separator partition secures and affirms the motor-mechanical set, and through it the electric connection cords pass (Not shown). Being located in a central compartment of the chassis, an electric bidirectional motor (1), with power of 1/50 HP (0.02 HP), is connected and controlled by a tripolar switch (12) for the options ON-OFF-ON, and which is ergonomically located for the hand position, in the external form of the chassis. The switch (12) also has an orientation of three buttons logically aligned in the directional direction of the brush movement rotation, making logical the mental exercise of pressing the button that aligns the rotation direction with the turn direction required to brush each maxillary. The switch (12) also has on each button, pilot lights type LED with indication arrow shape towards the turn direction.

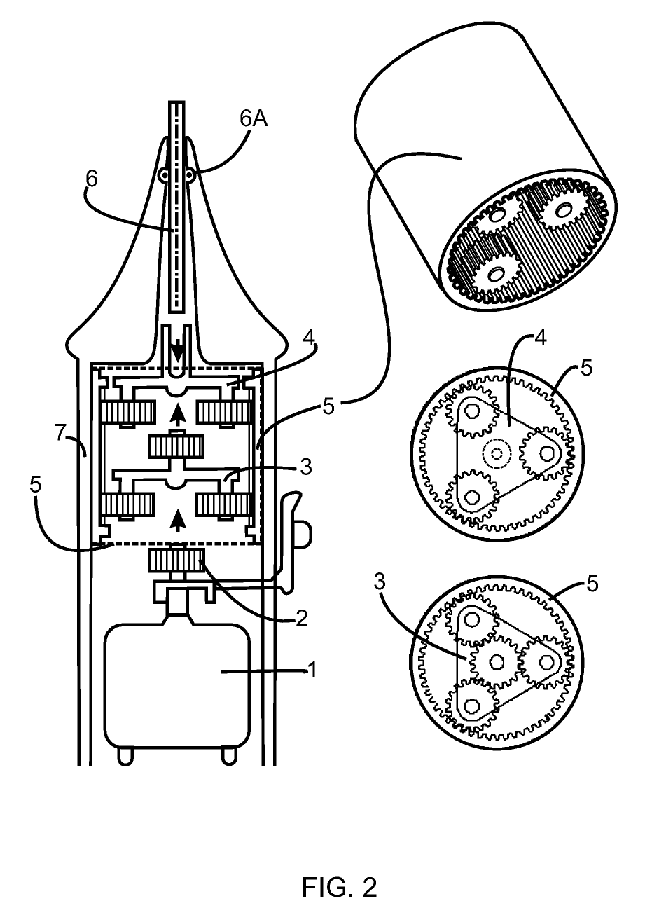

In reference to FIG. 2, the electric motor is shown (1); it has a force gear in its axis (2) to transmit the movement to the first revolving set of satellite gears (3), which is the first component of the gears reducing case. This set turns within a jagged cylindrical case (5). The first triangular gears set has a central gear in its axis which provides the traction force to the second revolving set of satellite gears (4); This second revolving set is also located within an exterior cylindrical jagged case (5).

The second revolving set has a output central socket axis; this socket axis receives and connects the plug axis (6), this is the long spear, which projects along the chassis neck; this axis, as shown in figure (1), has a supplementary anti-moisture packing (6A) (O-ring gasket type), which is located in the end of the chassis terminal output. This axis connects in its end through a bolt (6B), to the bush set (8). The brush has a cover (14), to protect it when used.

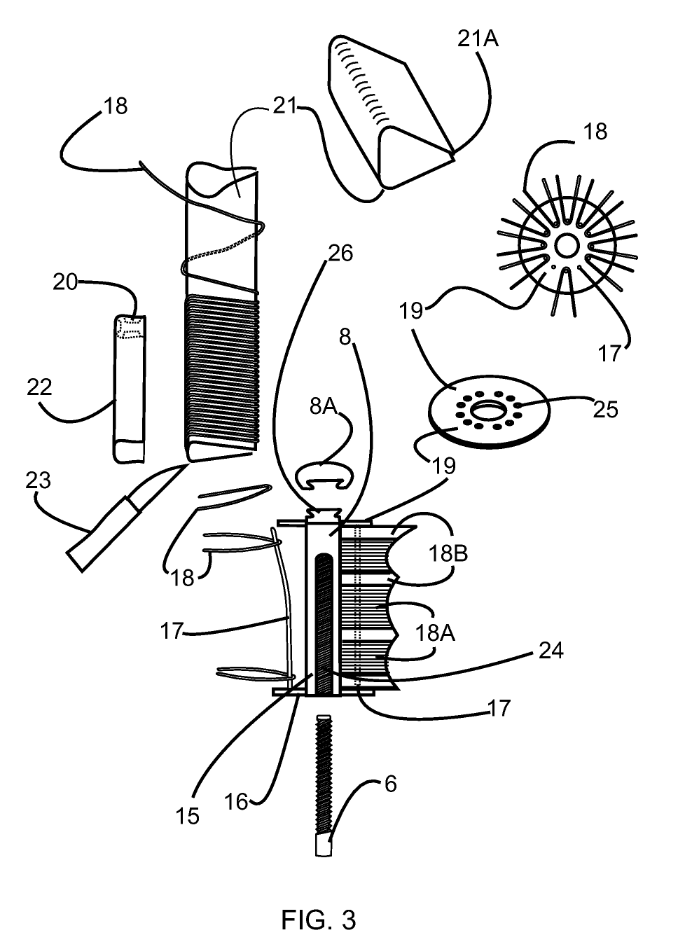

The FIG. 3. shows the details of the components of the brush head (8). The brush head (8) assembles firmly on the aforesaid rigid axis (6), through twisted penetration welded with a plastic material between the axis (6) and a central hole (24) of the component plastic heart (15). This heart (15) has a fin-flange (16) on its initial base to confine the bristles body (18). On the fin-flange (16) the bristles retainer sticks (17) are secured. The retainer sticks (17) have the sufficient flexibility to open outward from the heart axis (15) in order to permit the entry of the bristles (18). The bristles (18) enter in loop form. The bristles (18) assemble as mentioned below. The bristles (18) have two types of materials, of flexible rubber (18A) and of nylon (18B). When the bristles (18) fill up the retainer sticks set (17), the sticks (17) are secured through a plastic washer (19) by means of the cavities (25) that receive the tip of the retainer sticks (17). This terminal washer (19) confines the whole head brush set (8) by welding it to the heart (15) and the tip of the retainer sticks (17). There is a short portion of the plastic heart axis (26) protruding from the terminal washer (19) that constitutes the terminal tip of the head brush, this tip (26) is protected by a button of soft material called soft bumper (8A) that protects it from hits.

According to the FIG. 3, it shows a method of preformed and assembly through a bristle feeder device set. The bristle feeder device set has three accessories: a pipe-guide (21), a jockey holder and pusher (22) and a cutter (23). The pipe-guide (21) it is a tube with a sharp angle contour to permit the proximity towards the axis heart (15) of the brush head (8). This tube (21) also has a slot (21A) that permits the entry of the retainer stick (17), making easier the bristles (18) delivery. The jockey holder-pusher accessory (22) presses and secures the bristles (18) that have been already rolled up in the pipe-guide (21). The jockey holder and pusher (22) moves lengthwise on pipe-guide (21), and through a short nails (20) displaces the whole set of preformed bristles (18), within the retainer stick (17). The third component of the method of preformed and assembly is a bristle cutter (23). The cutter (23) cuts the loops of preformed bristle (18) opportunely in order to give to the bristles (18) a “U” shape as shown in the plan.

### BEST WAY TO PERFORM THE INVENTION

The reversible electric toothbrush of bidirectional rotation with speed reducing case has a tubular case chassis of housing and is externally covered by an anti-moisture antiskid polyurethane cover. The chassis is the structure to house and secure different elements related below:

The end of the case serves as support base so that the device stays vertically (end opposite to the tip where the brush itself is located). It has a secondary electric coil that officiate the wireless loader, which receives the reload power by inductance. The coil is connected to a component of reloadable batteries package that offers a supply of 3.4 volts and ≧900 milliamperes hour.

The batteries package is connected through a cabling passing through an adherence partition. The partition firmly secures the motor-mechanical set that follows it. The aforesaid cabling passing through the partition is connected to an electric motor.

The brush electric motor produces 1.250 revolution per minute (RPM) with a power of horsepower (HP). This is a bidirectional motor.

The motor has a bidirectional switch of three positions. The switch may activate the bidirectional motor to ON in the clockwise direction, or to OFF position. The switch is located out the case-chassis ergonomically located in the level of manual holding corresponding to the thumb.

A force traction gear is located in the electric motor axis and connects to a redactor cage set:

The reducing case has 2 sets or triangular kits of satellite gears. Each set has 3 satellite gears and turns within a jagged cylindrical case that serves as casing and rotation confined field. This reducing case set provides a reduction relation from 6 to 1 that decreases the 1250 revolutions per minute of the aforesaid electric motor to a speed of rotation of the output axis to ≦210 revolutions per minute (RPM). Such reducing case has a socket output axis that gives power and connects as a fixation point to a following component called stainless steel spear axis.

The stainless steel spear axis has an adherence pin or cot in its “plug” end that secures the effective force transmission in any of the directional direction of rotation of such axis and secures the non longitudinal displacement of the axis in its connection point with the reducer gear cage. This axis has an annular rubber gasket (O-ring gasket) near to the exit of the chassis that has as function to retain the humidity inbounded the device.

The spear axis due to its longitude projects within the oral cavity and has in its final end a replacement brush head constituted by bristles that turn on their own axis and form a cylindrical and conic shape with crests and fences, where the crests are formed by nylon bristles of greater longitude and the fences are formed by rubber bristles of smaller longitude.

The reversible electric toothbrush of bidirectional rotation on its own axis is composed by a chassis that has elements permitting the rotational movement and is also composed by a replacement head that turns on its own axis.

The brush head is formed by crests and fences in its cylindrical peripheral surface of 360°. The bristle length ensures an external diameter of the brush head of ≧10 mm and ≦15 mm (≧0.4 inches and ≦0.6 inches).

The longitude of the brush head composed by a set of bristles is 23 mm (0.9 inches). The brush head has a plastic central axis of ≦5 mm diameter (0.2 inches) where the bristles are fixed and has a central hole of one millimeter (0.04 inches) that houses the aforesaid metallic spear axis joined by a welded and firm union. The brush head central axis end has in its most distant end a soft button of polyurethane sanitary material that acts as a soft bumper, avoiding impacts against the mouth hard and soft surfaces.

The reversible electric toothbrush of bidirectional rotation with speed reducing case has a total longitude greater than or equal to ≦20 cm (greater than or equal to ≦7.9 inches). This device has a structural chassis of irregular diameter according to the ergonomic contour from 28 to 32 mm (1.1 to 1.2 inches).

The reversible electric toothbrush of bidirectional rotation with speed reducing case has an external separate support that acts as socket-base-plug, where the brush is located and remains standing.

The base has an electric coil in shape of primary coil in its interior to transform the electric power available in the network and supply load power by inductance to the secondary electric coil that is located in the device base end. This way, the necessary power required by the reloadable batteries package is transformed.

The base has plug legs to be connected to a network current source. The base has a structural shape in its inferior end to provide a firm adhesion to the electric connector.

The reversible electric toothbrush of bidirectional rotation with speed reducing case has between 20-30% of nylon bristles with a diameter of 0.14 mm (0.005 inches) that penetrate within the teeth and the patches of the molar base and has between 70-80% of elastic rubber bristles in thread shape with a diameter of 0.9 mm (0.03 inches) that make the clean and polish action (polished) to the dental surface and also clean the oral soft tissues.

The percentage of nylon bristles is between 20-30% and their characteristics of longitude and diameter added to the rotation direction of the brush set in the right direction favoring the gums acting with the softness necessary to not damage the gums.

The percentage of elastic rubber bristles is between 70-80% with characteristics of longitude and diameter that clean and also exert a massage action stimulating the gums by maintaining and/or recovering the right position in the gums line.

The cover for protection and keeping of the brush protects the bristles against the external dirt and the maltreatment or mechanical damage when the brush is not used.

For the construction of the brush head, the bristles are secured to the central axis of the brush head plastic central axis with bristles retainer sticks that adjust with washers that secure the ends of the assembled brush.

Within the method for the assembly of the head of the reversible electric toothbrush of bidirectional rotation on its own axis, the use of an accessory that may have one or several pipe-guide to perform, guide, introduce and release the bristles within the bristles retainer sticks is recommended such as described in the figures.

1. A reversible electric toothbrush bidirectionally rotating on an axis comprising:
a mechanism configured to make toothbrush bristles clean in a gum-teeth direction, wherein the dental neck remains uncovered and the dental gums are prevented from being hit;
a motor comprising a reducer speed case including gears balancing at least one of: speed, force, and torque characteristics to reduce a rotating speed of said toothbrush when said toothbrush is activated.

2. The reversible electric toothbrush of claim 1, wherein said rotating speed is varied from about ≧1250 RPM to about ≦210 RPM.

3. The reversible electric toothbrush of claim 1, wherein said mechanism is configured to allow choosing the rotating direction of said bristles so that a user selectively sets a gum-tooth direction that favors the gums covering the uncovered necks.

4. The reversible electric toothbrush of claim 1, wherein said reducer speed cage comprises a plurality of gears selectively located within a jagged cylindrical cage; said motor comprises a central gear coaxially positioned in a motor rotating axis and selectively configured to produce a traction force which is transmitted among said plurality of gears through the internal walls of the reducing case.

5. The reversible electric toothbrush of claim 1, wherein said motor outputs a power of about 0.02 HP producing a uniform and continuous action.

6. The reversible electric toothbrush of claim 1, wherein a teeth brushing operation depends from at least one of: power and speed of the movements generated by said reducing case which conditions said motor speed.

7. The reversible electric toothbrush of claim 1, wherein said bristles comprise:
from about 20% to about 30% nylon bristles selectively configured to penetrate the spaces between teeth and the patches of the molar bases; and
from about 70% to about 80% rubber bristles selectively configured to polish and clean the teeth.

8. The reversible electric toothbrush of claim 1, further comprising a superior end including a rubber cover that decreases a hitting intensity when said brush gets in contact with the mouth internal parts.

9. The reversible electric toothbrush of claim 1, further comprising:
a chassis including elements allowing rotational movement; and
a replaceable head comprising bristles selectively configured to rotate on said axis, wherein said bristles are configured to form a cylindrical and conical shape with crests comprised of longitudinally larger bristles and fences comprised of longitudinally smaller bristles.

10. The reversible electric toothbrush of claim 9, wherein said crests comprise nylon bristles and said fences comprise rubber bristles.

11. The reversible electric toothbrush of claim 8, wherein said superior end comprises a waterproof packing configured to prevent liquids from entering a brush case.

12. The reversible electric toothbrush of claim 1, further comprising a casing encompassing: said motor, said speed reducing case, a switching element selectively controlling the direction of rotation, an indicating element indicating the direction of rotation and a power providing element.

13. The reversible electric toothbrush of claim 1, further comprising;
a brush head selectively configured to be assembled by means of a twist action between said head and a case;
at least one of: nylon bristles and rubber bristles;
a rubber cover; and
a tubular contour comprising a rising easel allowing the bristles to be fitted when assembled.
